(19) United States
(12) Patent Application Publication
(10) Pub. No.: US 2002/0108605 A1
(43) Pub. Date: Aug. 15, 2002

(54) Air and fuel management and delivery system

(76) Inventors: Torey W. DeGrazia JR., Park Ridge, IL (US); Margaret Rajski, Ingleside, IL (US)

Correspondence Address: Pauley Petersen Kinne & Erickson, Suite 365, 2800 West Higgins Road, Hoffman Estates, IL, 60195, US

(21) Appl. No.: 10/054,481

(22) Filed: Nov. 13, 2001

Related U.S. Application Data
(60) Provisional application No. 60/153,733, filed on Sep. 13, 1999.
(60) Provisional application No. 60/157,090, filed on Oct. 1, 1999.
(60) Provisional application No. 60/261,971, filed on Jan. 15, 2001.

(51) Int. Cl. F02M 27/00

(52) U.S. Cl. 123/538; 123/541; 123/557

(57) ABSTRACT

A fuel management and delivery system for a vehicle having a fuel tank supplying an engine includes a heat exchanger positioned within a sender unit positioned within the fuel tank and at least one insulated fuel line extending between the fuel tank and the engine. A controller may be connected with respect to the heat exchanger for regulating a temperature of the heat exchanger and fuel within the insulated fuel line.

### BACKGROUND OF THE INVENTION

1. Field of the Invention

This invention relates to an air and fuel management and delivery system that enables an enhanced flow of temperature-controlled, magnetically influenced forced air and fuel to the combustion cycle of internal combustion, turbine-type and other engines.

2. Description of Related Art

Conventional air induction systems have an air filter assembly located in or outside of the engine compartment of the vehicle. An air filter is required at the air intake manifold to filter air as it enters the engine. Unfiltered inducted air generally contains dirt particles and other contaminants and has a temperature equal to or greater than the ambient temperature outside the vehicle. During periods of extremely hot or cold weather conditions, fuel consumption increases. Air filters that are currently being used today are made of rigid tubing, have a paper air filter element, and are enclosed in a restrictive housing. These air filters, which are located either inside or outside the engine compartment, place obstructions in the path of the incoming air and thereby restrict its movement.

More and more manufacturers are providing heating, ventilating, and air conditioning (HVAC) systems that use filtered air. The air induction system according to one preferred embodiment of this invention will use filtered, temperature-stabilized air as a supply of combustion air for the engine thereby eliminating the need for a separate air filter and the restriction in airflow associated with the filter.

In addition, the air induction system will maintain the temperature of the inducted air at a more steady state by using the HVAC system and insulated ductwork to eliminate temperature extremes. Maintaining the inducted air at a more stable and even air temperature is extremely important for fuel economy and emissions control, especially under cold and extremely hot weather conditions. According to the U.S. Environmental Protection Agency's (USEPA's) “Fuel Economy Impact Analysis of RFG” (EPA 420-F95-003, August 1995), lower winter temperature (20° F. versus 77° F.) can decrease fuel economy by 13 percent, notwithstanding the use of reformulated fuel.

In addition, conventional fuel delivery systems provide fuel to the combustion cycle of the engine at or near ambient temperatures. As a result, during warm conditions, warm fuel is delivered to the combustion cycle at an increased vapor index over optimum and during cold conditions, cold fuel is delivered to the combustion cycle at a reduced vapor index from optimum.

### SUMMARY OF THE INVENTION

It is one object of this invention to provide an air and fuel management and delivery system that reduces fuel consumption.

It is another object of this invention to provide an air and fuel management and delivery system that reduces air emission levels.

It is yet another object of this invention to provide a fuel management and delivery system that uses a heat exchanger in the fuel tank to provide temperature control to the fuel prior to combustion.

It is another object of this invention to provide an air induction system that draws filtered, temperature-controlled air from the passenger compartment and/or the HVAC plenum into the air intake manifold.

It is yet another object of this invention to provide a fuel management and delivery system that may be used in concert with an air induction system to reduce engine emissions and provide greater efficiency.

The fuel management and delivery system according to a preferred embodiment of this invention is used for a vehicle having a fuel tank supplying an engine. A heat exchanger is preferably positioned within the fuel tank. The heat exchanger preferably heats and/or cools fuel within the fuel tank which is then directed through a fuel line extending between the fuel tank and the engine. When the fuel that is heated or cooled from ambient temperatures is delivered to the combustion cycle, emissions may be reduced and engine may bum the fuel more efficiently. The fuel lines and/or fuel tank may be insulated to preserve the temperature of the fuel within the fuel tank and/or the fuel lines.

The heat exchanger may be positioned within a sender unit in the fuel tank. New or existing electric connectors on the sender unit may be used for connection of a power supply to supply heat exchanger with a current and/or a signal.

In addition, the heat exchanger may comprise one or more coolant lines extending between the engine compartment and the fuel tank. The coolant lines may extend from an air conditioning unit or other heat exchanger within the vehicle and may extend within close proximity to the fuel line between the engine compartment and the fuel tank.

The heat exchanger may be manually and/or automatically controllable based upon manual input and/or automatic temperature sensing, such as from a thermostat and/or a controller. The heat exchanger may be operatively connected with respect to a controller and controlled based upon a temperature, either of the fuel or of the ambient air.

The fuel delivery system and the air induction system according to the preferred embodiments of this invention can be installed into a vehicle during or after the manufacturing process. Preferably, the air induction system described below is connected to a filtered HVAC system of the vehicle.

The air induction system according to a preferred embodiment of this invention is used in connection with vehicles having an engine with an air intake manifold. Preferably, an interior air inlet is positioned in communication with a passenger compartment of the vehicle. Alternatively, or additionally, a plenum outlet is positioned in an HVAC plenum of the vehicle to provide conditioned air from the HVAC plenum to the air intake manifold.

An air supply duct is provided to extend between the interior air inlet and/or the plenum outlet and the air intake manifold. The air supply duct resultingly supplies conditioned air from the passenger compartment and/or the HVAC plenum to the air intake manifold. In addition, a plurality of magnets are preferably positioned in or around the air supply duct and/or inside the fuel lines and/or fuel tank to improve fuel efficiency and/or emissions.

According to one preferred embodiment of the invention, an air diverter valve is connected within the air supply duct from the plenum chamber. The air diverter valve assembly directs the flow of air to the air intake of the engine and also the air distribution assembly of the passenger compartment. The air diverter valve preferably controls air flow into and out of the passenger compartment and/or the HVAC plenum and into the air intake manifold.

During cold weather conditions, hot air from the HVAC system is directed/drawn into the air supply duct. During hot weather conditions, cool air from the HVAC system is directed/drawn into the air supply duct. During weather conditions that do not require the use of HVAC-temperature-controlled air, air will be directed/drawn into the air supply duct from the passenger compartment. By responding to the ambient air temperature, the air diverter valve will enable the intake of air from the HVAC plenum and the passenger compartment or from the passenger compartment of the vehicle.

### BRIEF DESCRIPTION OF THE DRAWINGS

The above-mentioned and other features and objects of this invention will be better understood from the following detailed description taken in conjunction with the drawings wherein:

FIG. 1 is a schematic view of an air induction system according to the prior art;

FIG. 2 is a schematic view of the air induction system according to one preferred embodiment of this invention;

FIG. 3 is a schematic view of the air induction system according to one preferred embodiment of this invention;

FIG. 4 is a cross-sectional side view of a silencer according to one preferred embodiment of this invention;

FIG. 5 is a diagrammatic side view of a portion of a silencer according to one preferred embodiment of this invention;

FIG. 6 is a front view of a portion of a silencer according to one preferred embodiment of this invention;

FIG. 7 is a side view of a silencer according to one preferred embodiment of this invention;

FIG. 8 is a top schematic view of an air induction system and a fuel delivery system according to one preferred embodiment of this invention;

FIG. 9 is a side schematic view of a fuel delivery system according to one preferred embodiment of this invention; and

FIG. 10 is a perspective view of a fuel delivery system according to one preferred embodiment of this invention.

### DESCRIPTION OF PREFERRED EMBODIMENTS

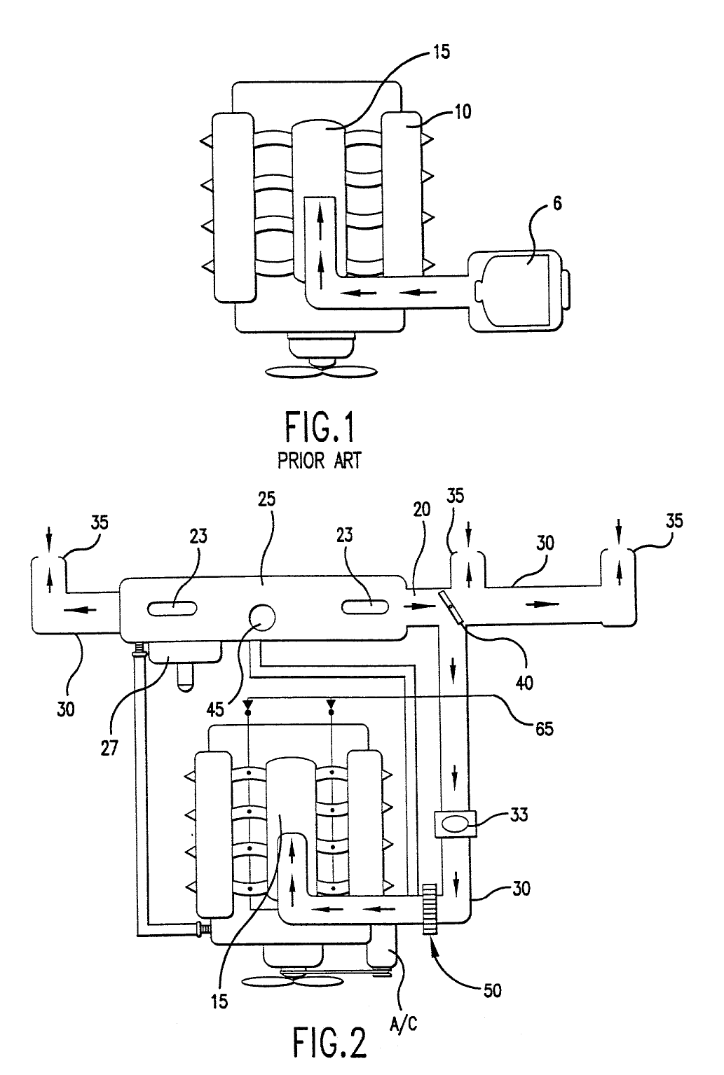

FIG. 1 shows a prior art air induction system wherein air flows from ambient and travels through an air filter 6 and into an air induction manifold 15 before entering engine 10. As shown in FIG. 2, the air induction system according to one preferred embodiment of this invention comprises an alternative system for providing air to air intake manifold 15 of engine 10.

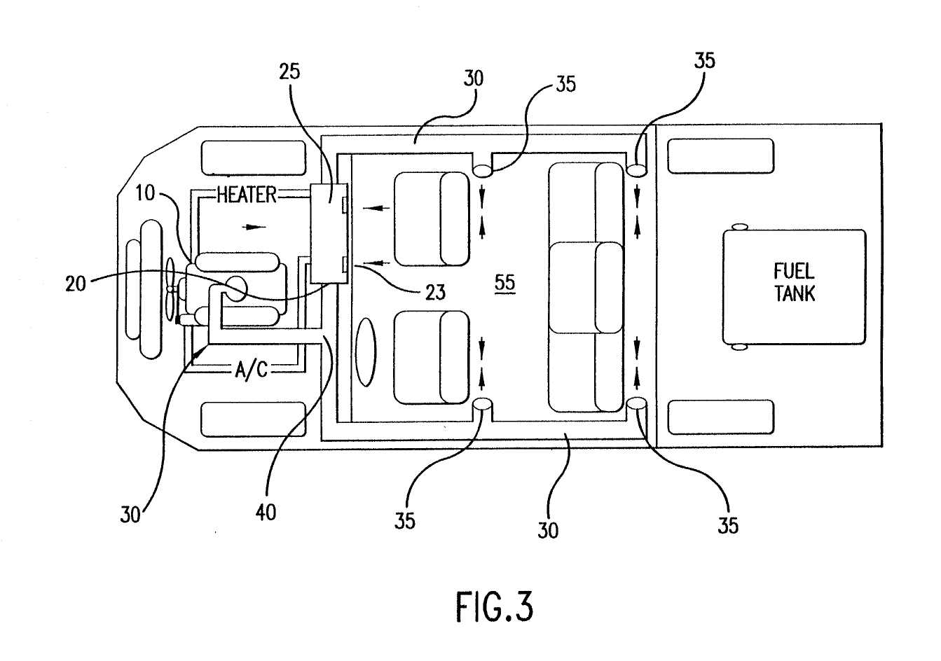

According to one preferred embodiment of this invention, as shown in FIGS. 2 and 3, one or more plenum outlets 20 are positioned within HVAC plenum 25 within the vehicles HVAC system. Fresh and/or recirculated air inlets 23 are necessarily required in conventional HVAC plenums 25. Plenum outlets 20 are preferably located in HVAC plenum 25 upstream of HVAC fan 27, shown in FIG. 2, that forces air into passenger compartment 55.

One or more interior air inlets 35 are preferably positioned within passenger compartment 55. Interior air inlets 35 may be positioned in existing internal vent locations or positioned in new locations suitable for drawing air from passenger compartment 55. Interior air inlets 35 may also be used as air outlets as required for providing conditioned air from the HVAC system to passenger compartment 55. Interior air inlets 35 may be situated in passenger compartment 55 of the vehicle as indicated in FIG. 3. The locations of interior air inlets 35 shown on FIGS. 2 and 3 are: (1) provided only for illustrative purposes; (2) may vary depending on the vehicle, the HVAC system and the type of engine; and (3) are not limited to these locations.

According to a preferred embodiment of this invention, air supply duct 30 extends from the HVAC plenum 25 to air intake manifold 15 of engine 10. Air supply duct 30 is preferably insulated to maintain a constant temperature of the air within air supply duct 30 and to preserve such constant temperature at the time of delivery of the air to air intake manifold 15. Insulation may be positioned externally along an outside surface of air supply duct 30 or otherwise positioned so as to preserve the temperature of the air within air supply duct 30. The exact location, length and configuration of air supply duct 30 depends on the vehicle, however air supply duct 30 is preferably as short as practicable.

According to one preferred embodiment of this invention, air diverter valve 40 is positioned within HVAC plenum 25, within a portion of air supply duct 30, or within an air supply chamber between one or more plenum outlets 20 and one or more interior air inlets 35. According to one preferred embodiment of this invention, an automatically or manually controlled air diverter valve 40 is located downstream of HVAC plenum 25. Alternatively, air diverter valve 40 may be located within an air supply chamber or within HVAC plenum 25. The location of air diverter valve 40 shown in FIG. 1: (1) is provided only for illustrative purposes; (2) may vary depending on the vehicle, the HVAC system and the type of engine; and (3) is not limited to this location.

According to one preferred embodiment of this invention, one or more magnets 50, either permanent or electromagnets, are placed in and/or around air supply duct 30 and may also be placed within fuel lines 105 and/or fuel tank 95. The location of magnets 50 shown on FIG. 2: (1) is provided only for illustrative purposes; (2) may vary depending on the vehicle, the HVAC system and the type of engine; and (3) is not limited to this location. In addition or as an alternative, magnets 50 may be installed in or integrated with air intake manifold 15 at the time of manufacture. As a result of the positioning of such magnets 50 in and/or around air supply duct 30 and/or related components, a magnetic force field is created within and around the air supply duct 30 and/or in the fuel lines 105 and/or fuel tank 95 that results in a beneficial effect on fuel efficiency and emissions. Air supply duct 30 and the one or more magnets 50 around air supply duct 30 are preferably covered with insulation to maintain the steady temperature of the intake air.

If a filter is not included in the HVAC system or if a more thoroughly filtered airflow is required, filter 45 can be placed at air intake manifold 15 and/or air supply duct 30 of the HVAC system, as shown in FIG. 2. With filter 45 in place, the air induction system can be used in engines that do not have a filtered HVAC system air supply as part of the standard OEM. The location of filter 45 shown in FIG. 2: (1) is provided only for illustrative purposes; (2) may vary depending on the vehicle, the HVAC system, and the type of engine; and (3) is not limited to this location.

In one preferred embodiment of this invention, auxiliary fan 33 may be positioned within or in fluid communication with air supply duct 30 to enhance the flow of air moved by the HVAC system. Auxiliary fan 33 would also further enhance the flow of air to air intake manifold 15.

According to one preferred embodiment of this invention, one or more pressure-regulated airflow valves 65 are installed on or near air intake manifold 15. Airflow valves 65 as shown in FIG. 2 are preferably located on or near air intake manifold 15 to permit the circulation of air within air intake manifold 15; to maintain a constant pressure within air intake manifold 15, and to eliminate the damming of air within air supply duct 30.

The air induction system according to this invention preferably enables temperature-controlled air to be moved from passenger compartment 55 and/or the HVAC system to air intake manifold 15 of engine 10 through air supply duct 30. Air supply duct 30 is preferably sufficiently large to reduce the amount of resistance that occurs as the air moves from plenum outlets 20 and/or interior air inlets 35 to air intake manifold 15 of engine 10. The amount of the airflow may be enhanced by the use of auxiliary duct fan 33. Because the air that flows through air supply duct 30 is preferably filtered by the HVAC system and/or filter 45 on the plenum outlets 20, particulate matter and contaminants are removed from the system prior to the intake of air into air supply duct 30.

According to one preferred method of operation of this invention, air in air supply duct 30 within an optimal temperature range for combustion air will be drawn from HVAC plenum 25 and passenger compartment 55 or solely from HVAC plenum 25 or passenger compartment 55 of the vehicle.

HVAC plenum 25 is preferably connected to air supply duct 30 that is separated from HVAC plenum 25 by air diverter valve 40. Depending on the temperature of the ambient air, the automatically or manually thermally controlled air diverter valve 40 will direct air into air supply duct 30 of engine 10 from HVAC plenum 25 and passenger compartment 55 or solely from HVAC plenum 25 or passenger compartment 55 of the vehicle. Air diverter valve 40 will preferably respond to temperature changes and may be manually or computer controlled.

During cold weather conditions, hot air from the HVAC system is directed/drawn into air supply duct 30. During hot weather conditions, cool air from the HVAC system is directed/drawn into air supply duct 30. During weather conditions that do not require the use of HVAC-temperature-controlled air, air can also be directed/drawn into air supply duct 30 from passenger compartment 55. By responding to the ambient air temperature, air diverter valve 40 will enable the intake of air from HVAC plenum 25 and/or passenger compartment 55 of the vehicle depending upon the sensed conditions.

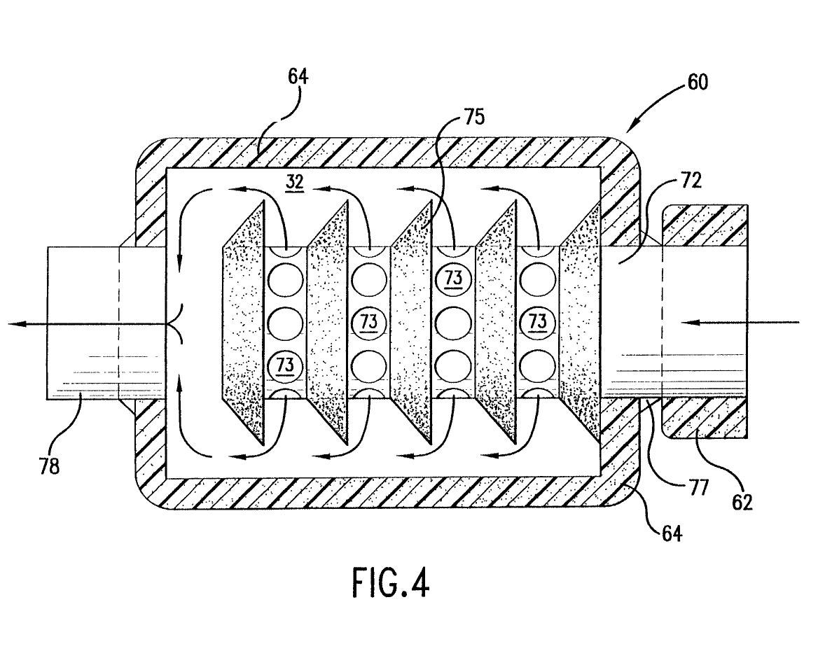

According to another preferred embodiment of this invention, as shown in FIGS. 4-7, air silencer 60 is used in connection with the air induction system to dampen noise both in passenger compartment 55 and externally of the vehicle. If necessary, air silencer 60 will be used to reduce the level of noise emanating from the air induction system. As shown in FIGS. 4-7, air silencer 60 includes inner air horn 62 and outer shell 64. Inner air horn 62 preferably includes a hollow, cylindrical body portion 72 having a plurality of apertures 73 and a forming bore 74. Preferably, but not necessarily, apertures 73 are arranged in bands around a circumference of body portion 72 as shown in FIGS. 4 and 5. A plurality of baffles 75 are positioned around the circumference of body portion 72. Preferably, but not necessarily, baffles 75 have a ring shape. It is apparent to one skilled in the art that baffles 75 may have any suitable shape. Baffles 75 are preferably made of a foam material. Other suitable materials for muffling sound known to those skilled in the art may be used to make baffles 75. Preferably, foam baffles 75 are positioned between adjacent bands of apertures 73 as shown in FIGS. 4 and 5.

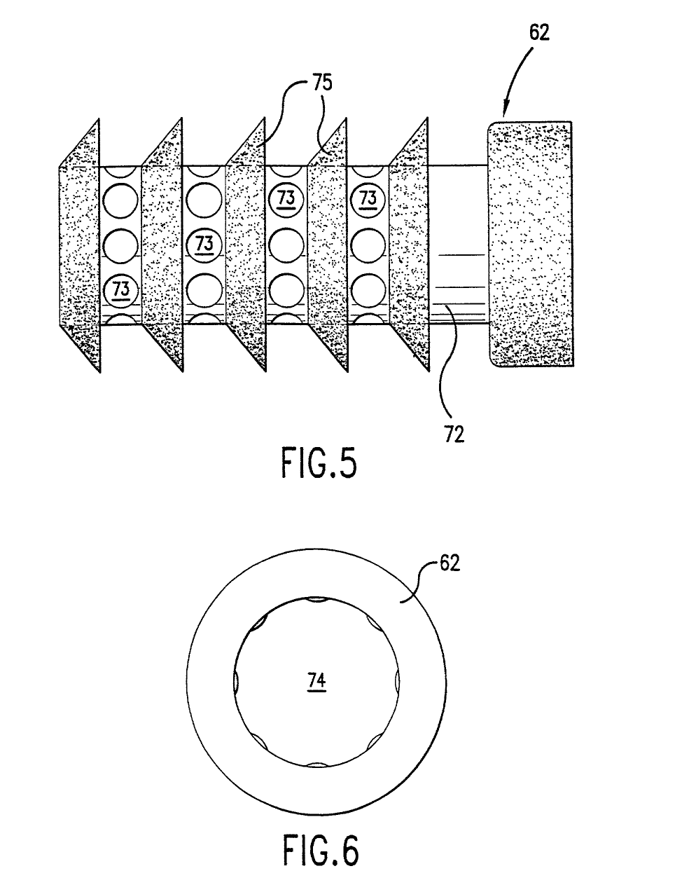

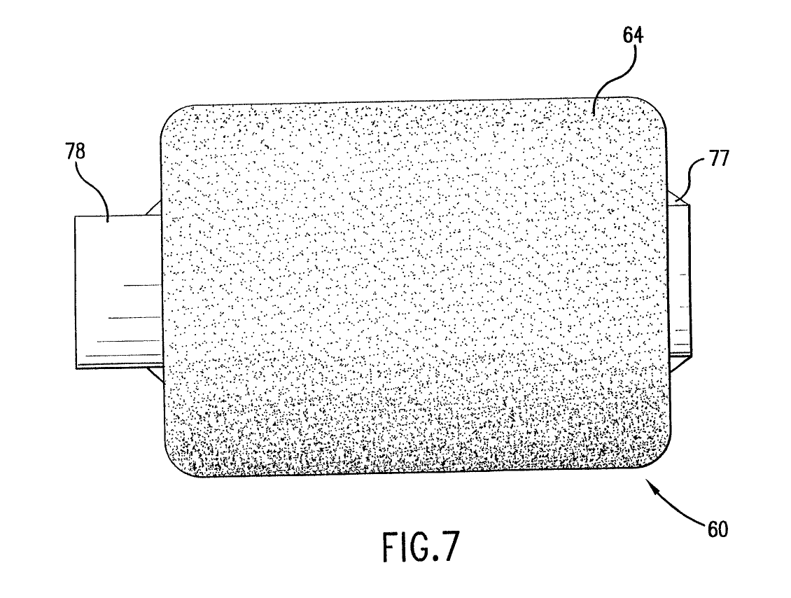

As shown in FIGS. 4 and 7, according to one preferred embodiment of this invention, outer shell 64 of air silencer 60 consists of two pieces. Preferably, the pieces of outer shell 64 generally have a semi-cylindrical shape. In one preferred embodiment of this invention, outer shell 64 is made of a liner, for example a plastic liner with foam insulation attached to an inner surface of the plastic liner. Each piece of outer shell 64 preferably includes lip portion 77 and outlet portion 78. Lip portion 77 and outlet portion 78 of each outer shell 64 have a generally semi-circular shape. When the pieces of outer shell 64 are connected, an inner cavity is formed as well as a lip portion 77 and an outlet portion 78. In the preferred embodiments according to this invention, inner air horn 62 is securely positioned within lip portion 77 of outer shell 64 to form air silencer 60 as shown in FIG. 4. FIG. 6 is a front view of air silencer 60 having inner air horn 62 securely positioned within outer shell 64. Air silencer 60 is attachable to each interior air inlet 35 to provide a free passage of air while reducing the noise level in interior air inlets 35.

According to another preferred embodiment of this invention, a fuel management and delivery system, such as shown in FIGS. 8-10, is used alone or in connection with air induction system as described above. The fuel management and delivery system is used for a vehicle having fuel tank 95 supplying engine 10.

Heat exchanger 100 is preferably positioned within fuel tank 95, which is preferably insulated. Heat exchanger 100 is preferably a heater element 115 drawing power efficiently from a battery, generator or other source within the vehicle. Heat exchanger 100 must be safe for use in combustible environments and resistant to deterioration within fuel tank 95.

Heat exchanger 100 preferably heats and/or cools fuel within fuel tank 95 which is then directed through fuel line 105, which is preferably insulated, and extends between fuel tank 95 and engine 10. When fuel that is heated or cooled from ambient temperatures is delivered to the combustion cycle, emissions may be reduced and engine 10 may burn the fuel more efficiently. As a result, during warm conditions, cool fuel may be delivered to the combustion cycle at an improved vapor index over ambient and during cold conditions, warmed fuel may be delivered to the combustion cycle at an increased vapor index from ambient.

According to one preferred embodiment of this invention, heat exchanger 100 is positioned within sender unit 110 in fuel tank 95. Sender unit 110 is typically used for fuel level sensor 140 and/or a fuel pump and is typically positioned within a wall of fuel tank 95. Electric connectors may be positioned through sender unit 110 to convey signals regarding the level of fuel tank 95. According to a preferred embodiment of this invention, electric connectors may additionally be positioned through sender unit 110 to convey information regarding fuel temperatures and/or ambient temperatures. Electric connectors may also be used for connection of a power supply by which to supply heat exchanger 100, such as heater element 115, with a current.

According to an alternative and/or additional embodiment of this invention, and as shown schematically in FIG. 8, heat exchanger 100 may comprise one or more heater/coolant lines 120 extending between engine compartment 11 and fuel tank 95. Heater/coolant lines 120 may extend from air conditioning unit 125 within engine compartment 11 or from another heat exchanger within the vehicle. According to one preferred embodiment of this invention, the one or more coolant lines 120 may extend in close proximity to insulated fuel line 105 and between engine compartment 11 and fuel tank 95. More specifically, coolant line 120 and fuel line 105 may be wrapped or coiled with respect to each other or may be positioned in an adjacent and proximate relationship.

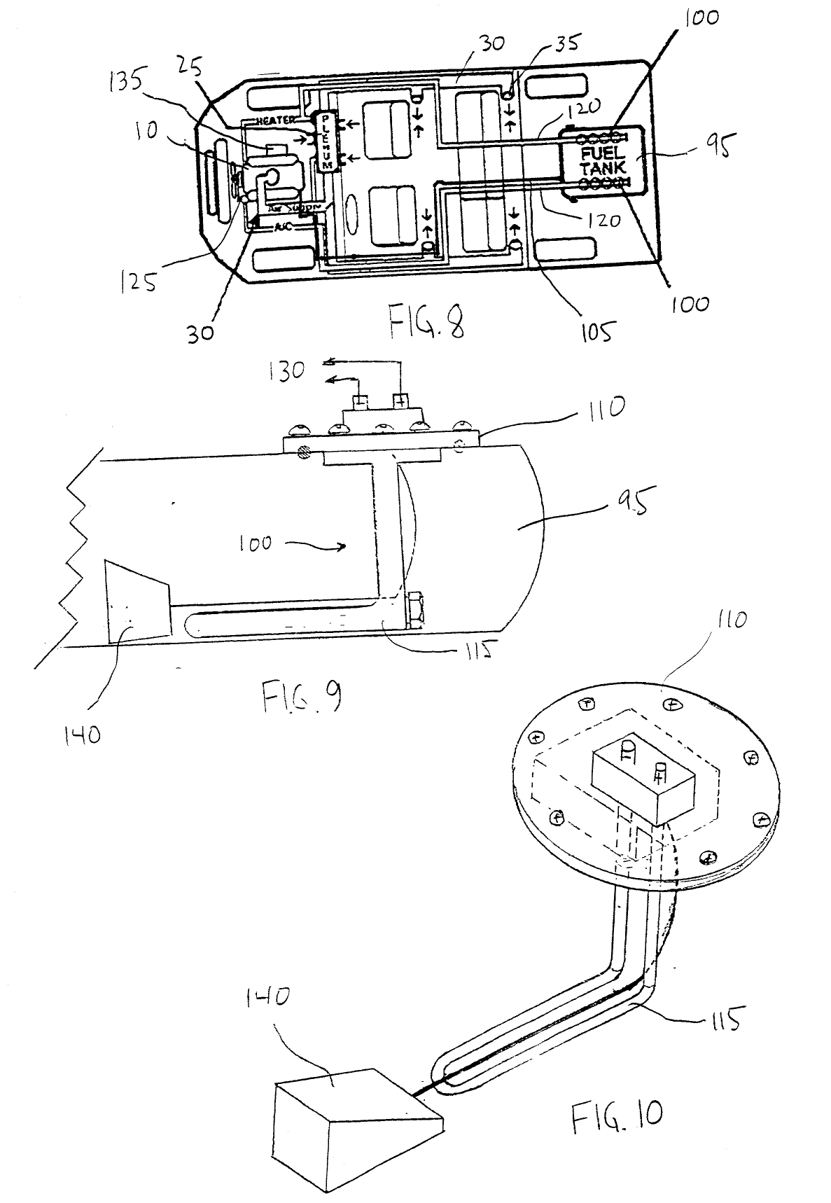

As shown in FIGS. 9 and 10, heat exchanger 100 may extend perpendicularly from sender unit 110 and into fuel tank 95. Heat exchanger 100 may also be positioned adjacent to or within close proximity to fuel level sensor 140 to facilitate interface with sender unit 110.

According to a preferred embodiment of this invention, heat exchanger 100 is manually and/or automatically controllable. Heat exchanger 100 may be operatively connected with respect to thermostat 130 and/or controller 135 and automatically controlled based upon a temperature, either of the fuel or of the ambient air, sensed by thermostat 130. In addition, or alternatively, a manual control and/or manual override may be positioned in communication with heat exchanger 100 to manually adjust the temperature of heat exchanger 100 and thus the temperature of fuel delivered to engine 10.

While in the foregoing specification this invention has been described in relation to certain preferred embodiments thereof, and many details have been set forth for purpose of illustration, it will be apparent to those skilled in the art that the system and method according to this invention are susceptible to additional embodiments and that certain of the details described herein can be varied considerably without departing from the principles of the invention.

We claim:

1. A fuel management and delivery system for a vehicle having a fuel tank supplying an engine, the fuel management and delivery system comprising:
a heat exchanger positioned within the fuel tank; and
an insulated fuel line extending between the fuel tank and the engine.

2. The fuel management and delivery system of claim 1 wherein the heat exchanger comprises:
a sender unit positioned within the fuel tank; and
a heater element positioned within the sender unit.

3. The fuel management and delivery system of claim 1 wherein the heat exchanger comprises:
one or more coolant lines extending between an engine compartment and the fuel tank.

4. The fuel management and delivery system of claim 3 wherein the one or more coolant lines extend from the air conditioning unit within the engine compartment.

5. The fuel management and delivery system of claim 3 wherein the one or more coolant lines are in close proximity to the insulated fuel line between the engine compartment and the fuel tank.

6. The fuel management and delivery system of claim 1 wherein the heat exchanger extends perpendicularly from a sender unit within the fuel tank.

7. The fuel management and delivery system of claim 1 wherein the heat exchanger is one of manually and automatically controllable.

8. The fuel management and delivery system of claim 1 wherein the heat exchanger is operatively connected with respect to a thermostat and automatically controlled based upon a temperature sensed by the thermostat.

9. The fuel management and delivery system of claim 1 wherein the heat exchanger is positioned adjacent to a fuel level sensor in the fuel tank.

10. A fuel management and delivery system for a vehicle having a fuel tank supplying an engine, the fuel management and delivery system comprising:
a heat exchanger positioned within a sender unit positioned within the fuel tank;
a fuel line extending between the fuel tank and the engine;
a controller connected with respect to the heat exchanger for regulating a temperature of the heat exchanger and fuel within the fuel line.

11. The fuel management and delivery system of claim 10 wherein the heat exchanger further comprises:
one or more coolant lines extending between an engine compartment and the fuel tank.

12. The fuel management and delivery system of claim 11 wherein the coolant lines extend from the air conditioning unit within the engine compartment.

13. The fuel management and delivery system of claim 10 wherein the beat exchanger further comprises a manual override for manually controlling the temperature of the heat exchanger.

14. The fuel management and delivery system of claim 10 wherein at least one of the fuel line and the fuel tank are insulated.

15. The fuel management and delivery system of claim 10 further comprising:
one or more magnets positioned with respect to at least one of the fuel line and the fuel tank.

16. A fuel management and delivery system for a vehicle having a fuel tank supplying an engine, the fuel management and delivery system comprising:
a heat exchanger positioned within an interior of the fuel tank;
one or more coolant lines extending between an engine compartment and the interior of the fuel tank;
a fuel line extending between the fuel tank and the engine; and
a controller connected with respect to the heat exchanger for regulating a temperature of the heat exchanger and fuel within the fuel line.

17. The fuel management and delivery system of claim 16 wherein the heat exchanger is positioned adjacent a fuel level sensor in the fuel tank.

18. The fuel management and delivery system of claim 16 wherein at least one of the fuel tank and the fuel line are insulated.

19. The fuel management and delivery system of claim 16 further comprising:
at least one magnet positioned within the fuel line.

20. The fuel management and delivery system of claim 16 further comprising:
at least one magnet positioned within the fuel tank.
